(19) United States
(12) Patent Application Publication
(10) Pub. No.: US 2026/0093244 A1
(43) Pub. Date: Apr. 2, 2026

(54) FORGING DEFECT PREDICTION APPARATUS, FORGING DEFECT PREDICTION METHOD, AND STORAGE MEDIUM

(71) Applicants: TOYOTA PRODUCTION ENGINEERING, Munakata City (JP); TOYOTA JIDOSHA KABUSHIKI KAISHA, Toyota-shi (JP)

(72) Inventors: Misa HAMATAKE, Toyota-shi (JP); Kazuhiro SUZUKI, Miyoshi-shi (JP)

(73) Assignees: TOYOTA PRODUCTION ENGINEERING, Munakata City (JP); TOYOTA JIDOSHA KABUSHIKI KAISHA, Toyota-shi (JP)

(21) Appl. No.: 19/330,035

(22) Filed: Sep. 16, 2025

(30) Foreign Application Priority Data
Sep. 27, 2024 (JP) 2024-168676

(51) Int. Cl. G05B 19/418

(52) U.S. Cl. CPC G05B 19/41875; G05B 2219/45244

(57) ABSTRACT

A forging defect prediction apparatus includes a processor. The processor is configured to calculate, based on a stress applied to a plurality of analysis meshes configuring a molded object model, a surface pressure of each of the analysis meshes, determine that a friction coefficient is Coulomb friction when the surface pressure of each of the analysis meshes is equal to or less than a predetermined threshold value and determine that the friction coefficient is shear friction when the surface pressure is greater than the predetermined threshold value, analyze the analysis mesh while switching the determined friction coefficient, and predict whether the defect phenomenon that occurs in the molded object model occurs based on a surface angle between surfaces of adjacent ones of the analysis meshes.

### CROSS-REFERENCE TO RELATED APPLICATION

This application claims priority to Japanese Patent Application No. 2024-168676 filed on Sep. 27, 2024. The disclosure of the above-identified application, including the specification, drawings, and claims, is incorporated by reference herein in its entirety.

### BACKGROUND

### 1. Technical Field

The present disclosure relates to a forging defect prediction apparatus, a forging defect prediction method, and a storage medium.

### 2. Description of Related Art

Forging molding in which an ingot-shaped or columnar lump of metal is plastically deformed and shaped by applying a large force to the lump of metal by hitting the lump of metal with a hammer or a mold is commonly performed. Analysis technologies that simulate the plastic deformation of the lump of metal that occurs during the forging molding have been known (for example, see Japanese Unexamined Patent Application Publication No. 2013-210735 (JP 2013-210735 A), Japanese Unexamined Patent Application Publication No. 2005-207774 (JP 2005-207774 A), Japanese Unexamined Patent Application Publication No. 2004-000781 (JP 2004-000781 A), and Japanese Unexamined Patent Application Publication No. 2009-059255 (JP 2009-059255 A)).

An analysis method of raw material deformation when casting molding is performed has also been known. For example, in Japanese Patent Application Publication No. 2018-118300 (JP 2018-118300 A), a technology that is an analysis method of raw material deformation in a die casting method has been disclosed. In the technology, a fixed-mold frictional stress applied to a predetermined section of a raw material from a fixed mold, in other words, a mold opening resistance due to a contact surface pressure of the fixed mold is analyzed with use of a friction coefficient function based on casting conditions and lubrication conditions.

### SUMMARY

However, the technologies in JP 2013-210735 A, JP 2005-207774 A, JP 2004-000781 A, JP 2009-059255 A, and JP 2018-118300 A cannot appropriately predict the occurrence of a defect when aluminum forging is performed. This is because Coulomb friction in which the frictional stress is in proportion to the contact pressure is used in those technologies and aluminum does not follow Coulomb's law of friction when the contact pressure becomes high.

Therefore, it is important to appropriately and efficiently predict the occurrence of a defect when aluminum forging is performed. It is also important to appropriately and efficiently predict the occurrence of a defect when various forging molding is performed.

The present disclosure provides a forging defect prediction apparatus, a forging defect prediction method, and a forging defect prediction program capable of appropriately and efficiently predicting the occurrence of a defect when forging molding is performed.

A forging defect prediction apparatus according to a first aspect of the present disclosure relates to a forging defect prediction apparatus configured to generate a molded object model in a plurality of molding processes of forging molding and predict, based on the molded object model, whether a defect phenomenon occurs when a molded object is molded by each of the molding processes of the forging molding. The forging defect prediction apparatus includes a processor, and the processor is configured to calculate, based on a stress applied to a plurality of analysis meshes configuring the molded object model, a surface pressure of each of the analysis meshes, determine that a friction coefficient is Coulomb friction when the surface pressure of each of the analysis meshes is equal to or less than a predetermined threshold value and determine that the friction coefficient is shear friction when the surface pressure is greater than the predetermined threshold value, analyze the analysis mesh while switching the determined friction coefficient, and predict whether the defect phenomenon that occurs in the molded object model occurs based on a surface angle between surfaces of adjacent ones of the analysis meshes.

In the forging defect prediction apparatus according to the first aspect of the present disclosure, the analysis mesh in each of the molding processes may include a plurality of nodes, and the processor may be configured to calculate the surface pressure based on an average value of a stress applied to the nodes.

In the forging defect prediction apparatus according to the first aspect of the present disclosure, the processor may be configured to determine the friction coefficient of the Coulomb friction when the surface pressure is smaller than a predetermined Coulomb threshold value based on the surface pressure, and decrease the friction coefficient based on the surface pressure when the surface pressure is greater than the Coulomb threshold value and is smaller than the predetermined threshold value.

In the forging defect prediction apparatus according to the first aspect of the present disclosure, the processor may be configured to predict that the defect phenomenon occurs when the surface angle between the surfaces of the adjacent analysis meshes is equal to or smaller than a predetermined angle threshold value and predict that the defect phenomenon does not occur when the surface angle between the surfaces of the adjacent analysis meshes is more than the predetermined angle threshold value.

In the forging defect prediction apparatus according to the first aspect of the present disclosure, the processor may be configured to calculate, when a gap exists between the molded object and a mold of the forging molding, the pressure of gas that exists in the gap, and analyze the analysis mesh based on the pressure of the gas.

A forging defect prediction approach in a second aspect of the present disclosure is a forging defect prediction method in a forging defect prediction apparatus configured to generate a molded object model in a plurality of molding processes of forging molding and predict, based on the molded object model, whether a defect phenomenon occurs when a molded object is molded by each of the molding processes of the forging molding. The forging defect prediction method includes a surface pressure calculating step of calculating, based on a stress applied to a plurality of analysis meshes configuring the molded object model, a surface pressure of each of the analysis meshes, a determination step of determining that a friction coefficient is Coulomb friction when the surface pressure of each of the analysis meshes is equal to or less than a predetermined threshold value and determining that the friction coefficient is shear friction when the surface pressure is greater than the predetermined threshold value, an analysis step of analyzing the analysis mesh while switching the friction coefficient, and a prediction step of predicting whether the defect phenomenon that occurs in the molded object model occurs based on a surface angle between surfaces of adjacent ones of the analysis meshes.

A non-transitory storage medium according to a third aspect of the present disclosure causes a processor to execute functions below. The processor is included in a forging defect prediction apparatus configured to generate a molded object model in a plurality of molding processes of forging molding and predict, based on the molded object model, whether a defect phenomenon occurs when a molded object is molded by each of the molding processes of the forging molding. The functions include calculating, based on a stress applied to a plurality of analysis meshes configuring the molded object model, a surface pressure of each of the analysis meshes, determining that a friction coefficient is Coulomb friction when the surface pressure of each of the analysis meshes is equal to or less than a predetermined threshold value and determining that the friction coefficient is shear friction when the surface pressure is greater than the predetermined threshold value, analyzing the analysis mesh while switching the friction coefficient, and predicting whether the defect phenomenon that occurs in the molded object model occurs based on a surface angle between surfaces of adjacent ones of the analysis meshes.

A program according to a third aspect of the present disclosure relates to a program executed by a forging defect prediction apparatus configured to generate a molded object model in a plurality of molding processes of forging molding and predict, based on the molded object model, whether a defect phenomenon occurs when a molded object is molded by each of the molding processes of the forging molding. The program causes the forging defect prediction apparatus to execute calculating, based on a stress applied to a plurality of analysis meshes configuring the molded object model, a surface pressure of each of the analysis meshes, determining that a friction coefficient is Coulomb friction when the surface pressure of each of the analysis meshes is equal to or less than a predetermined threshold value and determining that the friction coefficient is shear friction when the surface pressure is greater than the predetermined threshold value, analyzing the analysis mesh while switching the friction coefficient, and predicting whether the defect phenomenon that occurs in the molded object model occurs based on a surface angle between surfaces of adjacent ones of the analysis meshes.

With the present disclosure, it becomes possible to appropriately and efficiently predict the occurrence of a defect phenomenon when the forging molding is performed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a view showing an overview of a forging defect prediction apparatus according to Embodiment 1;

FIG. 1B is a view showing an overview of the forging defect prediction apparatus according to Embodiment 1;

FIG. 2 is a functional block diagram showing a configuration of the forging defect prediction apparatus shown in FIG. 1A and FIG. 1B;

FIG. 3 is a view showing one example of generation of analysis meshes;

FIG. 4 is an explanatory diagram for describing a relationship between a surface pressure and a frictional stress;

FIG. 5 is an explanatory diagram for describing the relationship between the surface pressure and the friction coefficient;

FIG. 6 is a flowchart showing a processing procedure of the forging defect prediction apparatus shown in FIG. 2;

FIG. 7 is a flowchart showing a processing procedure of friction coefficient determination processing shown in FIG. 6;

FIG. 8A is a view showing an overview of a forging defect prediction apparatus according to Embodiment 2;

FIG. 8B is a view showing an overview of the forging defect prediction apparatus according to Embodiment 2;

FIG. 8C is a view showing an overview of the forging defect prediction apparatus according to Embodiment 2;

FIG. 8D is a view showing an overview of the forging defect prediction apparatus according to Embodiment 2;

FIG. 8E is a view showing an overview of the forging defect prediction apparatus according to Embodiment 2;

FIG. 8F is a view showing an overview of the forging defect prediction apparatus according to Embodiment 2;

FIG. 9A is an explanatory diagram for describing a change of a gap;

FIG. 9B is an explanatory diagram for describing the change of the gap;

FIG. 9C is an explanatory diagram for describing the change of the gap;

FIG. 10 is a functional block diagram showing a configuration of the forging defect prediction apparatus according to Embodiment 2;

FIG. 11 is a flowchart showing a processing procedure of the forging defect prediction apparatus shown in FIG. 10; and

FIG. 12 is a diagram showing an example of a hardware configuration.

### DETAILED DESCRIPTION OF EMBODIMENTS

Embodiments of a forging defect prediction apparatus, a forging defect prediction method, and a forging defect prediction program according to the present disclosure are described in detail below with reference to the drawings.

### Embodiment 1

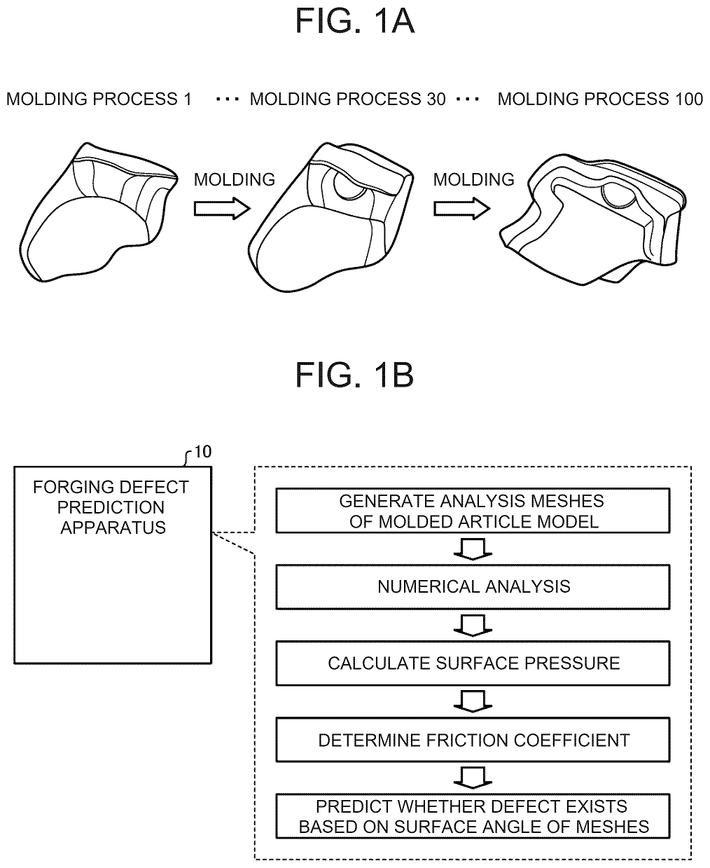

An overview of a forging defect prediction apparatus 10 according to Embodiment 1 is described. FIG. 1A and FIG. 1B are views showing an overview of the forging defect prediction apparatus 10 according to Embodiment 1.

### Overview of Forging Defect Prediction Apparatus 10

As shown in FIG. 1A, in the manufacturing of a product using a related-art forging technology, the product is molded by following a plurality of molding processes. Here, a state in which a molded object is prepared in a molding process 1, molding is repeated for each section in each molding process, a molding process 30 is performed, and the molding is completed in a molding process 100 is shown. A shape generated as a result of the material of a raw material being caught inside a mold used in the forging during the forging molding is referred to as a “defect”. In general, the place of occurrence is predicted in advance with use of analysis.

However, in the analysis, Coulomb's law of friction is used in the calculation of the frictional stress generated as a result of contact between the mold used in the forging and the material of the raw material. Therefore, defects have not been able to be predicted, and it has been a challenge to improve prediction accuracy.

As shown in FIG. 1B, in each molding process of the forging, numerical analysis is performed based on the molded object model, the calculation of the surface pressure and the determination of the friction coefficient are performed, and whether a defect exists is predicted. The forging defect prediction apparatus 10 generates a plurality of analysis meshes that forms a molded object model. The forging defect prediction apparatus 10 performs numerical analysis, calculates the stress at nodes of the analysis meshes based on the analysis meshes, and calculates the surface pressure based on the stress.

Subsequently, the forging defect prediction apparatus 10 determines the friction coefficient between the molded object and a mold based on the surface pressure. Here, when the surface pressure is lower than a predetermined threshold value, the friction coefficient is determined based on Coulomb's law of friction in which the frictional stress increases in accordance with the surface pressure. When the surface pressure is greater than the predetermined threshold value, the friction coefficient is determined based on shear friction law in which the friction coefficient becomes constant regardless of the surface pressure.

When the final process of the molding processes is completed, the forging defect prediction apparatus 10 calculates a surface angle of the analysis mesh with respect to an adjacent surface, and predicts whether a defect exists based on the surface angle. Specifically, it is predicted that a defect does not exist when a surface angle of the analysis mesh with respect to an adjacent surface is greater than a predetermined angle threshold value, and it is predicted that a defect exists when the surface angle is equal to or smaller than the predetermined angle threshold value.

### Configuration of Forging Defect Prediction Apparatus 10

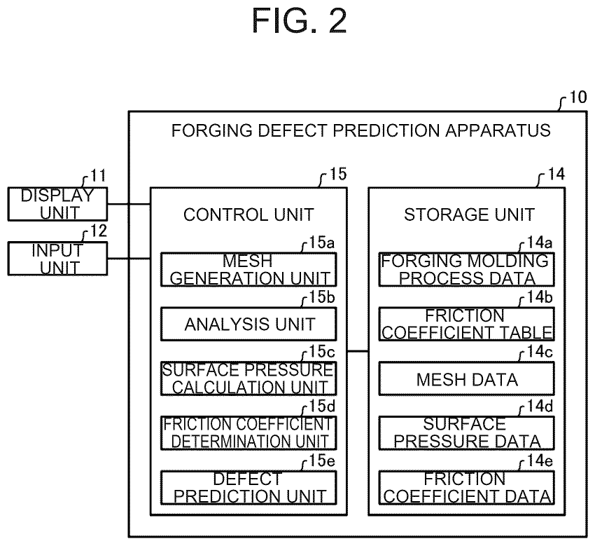

Next, a configuration of the forging defect prediction apparatus 10 shown in FIG. 1A and FIG. 1B is described. FIG. 2 is a functional block diagram showing the configuration of the forging defect prediction apparatus 10 shown in FIG. 1A and FIG. 1B. As shown in FIG. 2, the forging defect prediction apparatus 10 includes a display unit 11, an input unit 12, a storage unit 14, and a control unit 15. The display unit 11 is a display device such as a liquid-crystal display that displays various information. The input unit 12 is an input device such as a mouse or a keyboard.

The storage unit 14 is a storage device such as a hard disk apparatus or a non-volatile memory and stores therein forging molding process data 14a, a friction coefficient table 14b, mesh data 14c, surface pressure data 14d, and friction coefficient data 14c. The forging molding process data 14a is data on molded object models in molding processes using the forging technology. The friction coefficient table 14b is data indicating a relationship of the friction coefficient with respect to the surface pressure.

The mesh data 14c is a plurality of mesh data generated with respect to a front surface of the molded object model in order to perform the analysis of the molded object model. The surface pressure data 14d is data on the surface pressure calculated at the nodes of each analysis mesh. The friction coefficient data 14e is data on the friction coefficient at the nodes of each mesh determined based on the surface pressure.

The control unit 15 is a control unit that controls the entire forging defect prediction apparatus 10 and includes a mesh generation unit 15a, an analysis unit 15b, a surface pressure calculation unit 15c, a friction coefficient determination unit 15d, and a defect prediction unit 15c. In practice, processes corresponding to the mesh generation unit 15a, the analysis unit 15b, the surface pressure calculation unit 15c, the friction coefficient determination unit 15d, and the defect prediction unit 15e are executed by loading programs thereof into a CPU and executing those programs.

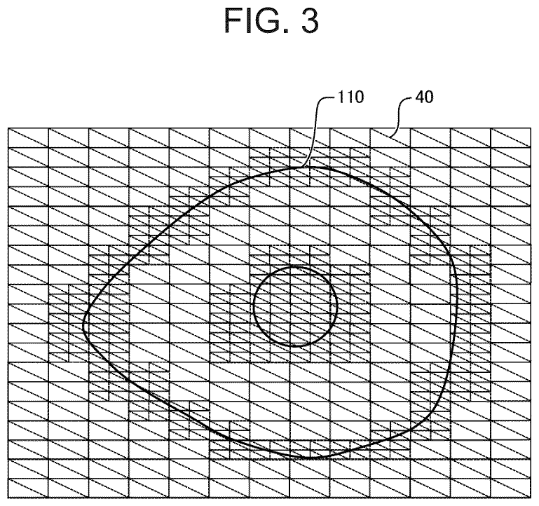

The mesh generation unit 15a is a processing unit that generates a plurality of meshes 40 for analysis with respect to the molded object model. Regarding the size of the generated meshes 40, the density of the meshes 40 is changed in accordance with the shape of the molded object model. For example, as shown in FIG. 3, the meshes 40 that are fine are generated in regions including changes in the shape of a molded object model 110.

The generated mesh data is associated with a forging molding process ID and is stored in the storage unit 14 as the mesh data 14c. Here, a case in which the meshes 40 each having a triangular shape are generated with use of diagonals of rectangular shapes is described, but the meshes 40 having any triangular shape may be generated. The shape of each of the meshes 40 may be a quadrilateral shape, a hexagonal shape, or the like.

The analysis unit 15b is a processing unit that performs numerical analysis based on the nodes of the generated meshes. As the numerical analysis, a finite element method and the like are used. The analysis unit 15b performs analysis based on the friction coefficient between the molded object and the mold determined by the friction coefficient determination unit 15d.

The surface pressure calculation unit 15c is a processing unit that calculates the surface pressure applied to the molded object model from a mold based on the stress in the nodes of each mesh. Specifically, a surface pressure P is calculated with use of Expression (1) based on a stress σ₁₁ in an X-axis direction, a stress σ₂₂ in a Y-axis direction, and a stress σ₃₃ in a Z-axis direction at the nodes of the meshes. Here, the surface pressure P is an average value of the stress.

$$Expression 1$$

$$P = - ( \frac{{σ}_{11} + {σ}_{22} + {σ}_{33}}{3} ) \qquad ( 1 )$$

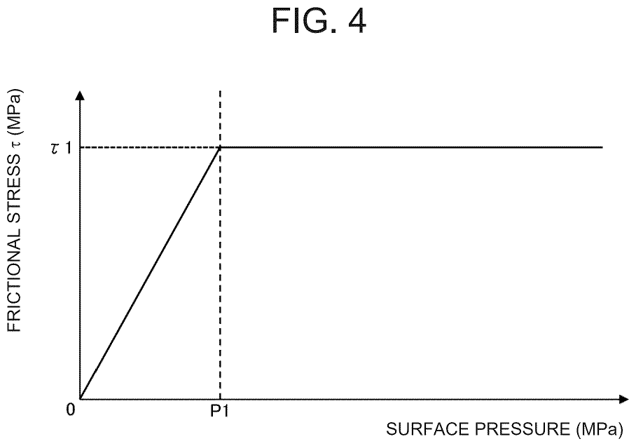

The friction coefficient determination unit 15d is a processing unit that determines the friction coefficient between the molded object and the mold based on the surface pressure. As shown in FIG. 4, the friction coefficient determination unit 15d determines the friction coefficient such that a frictional stress τ follows Coulomb's law of friction in which the frictional stress τ increases in accordance with the surface pressure from when the surface pressure is 0 (MPa) to when the surface pressure becomes a predetermined threshold value P1 and that the frictional stress τ follows shear friction law in which the frictional stress τ is constant at τ1 (MPa) when the surface pressure is equal to or more than the predetermined threshold value P1.

This is because the following occurs as characteristics of the frictional interface in forging. When the surface pressure is low, contact is obtained at tops (real contact points) of fine protrusions existing on a solid front surface due to the roughness of the solid front surface. When the surface pressure increases, the area (real contact area) of those real contact points increases. Therefore, in accordance with Coulomb's law of friction in which the frictional stress changes in accordance with the surface pressure, when the surface pressure becomes greater than the predetermined threshold value P1, the material of the raw material and the mold are placed in a state of being in contact with each other over almost the entire area, and the real contact area stops changing in accordance with the fluctuation of the surface pressure. Therefore, the frictional stress starts to follow shear friction law.

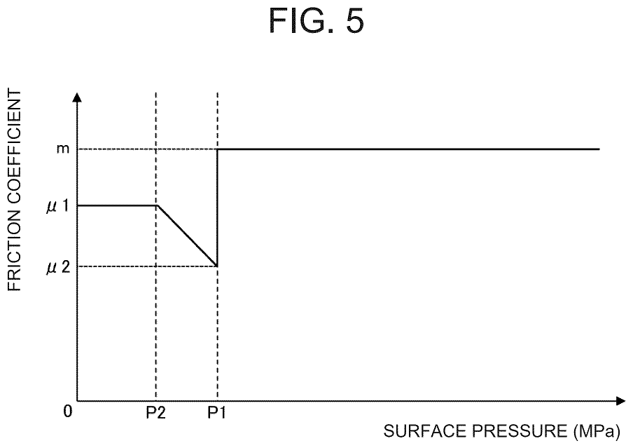

As shown in FIG. 5, the friction coefficient determination unit 15d has a feature in which the friction coefficient is constant at μl when the surface pressure P is smaller than a predetermined Coulomb threshold value P2 and the friction coefficient decreases in accordance with the increase of the surface pressure P when the surface pressure P is greater than the predetermined Coulomb threshold value P2 and smaller than the predetermined threshold value P1. This determination is stored in the storage unit 14 as the friction coefficient table 14b, and the friction coefficient determination unit 15d determines the friction coefficient based on each surface pressure.

The defect prediction unit 15e is a processing unit that calculates the surface angle between the adjacent surfaces of the analysis meshes and predicts whether a defect exists based on the surface angle. Specifically, it is predicted that a defect does not exist when the surface angle is greater than a predetermined angle threshold value, and it is predicted that a defect exists when the surface angle is equal to or smaller than the predetermined angle threshold value.

### Processing Procedure of Forging Defect Prediction Apparatus 10

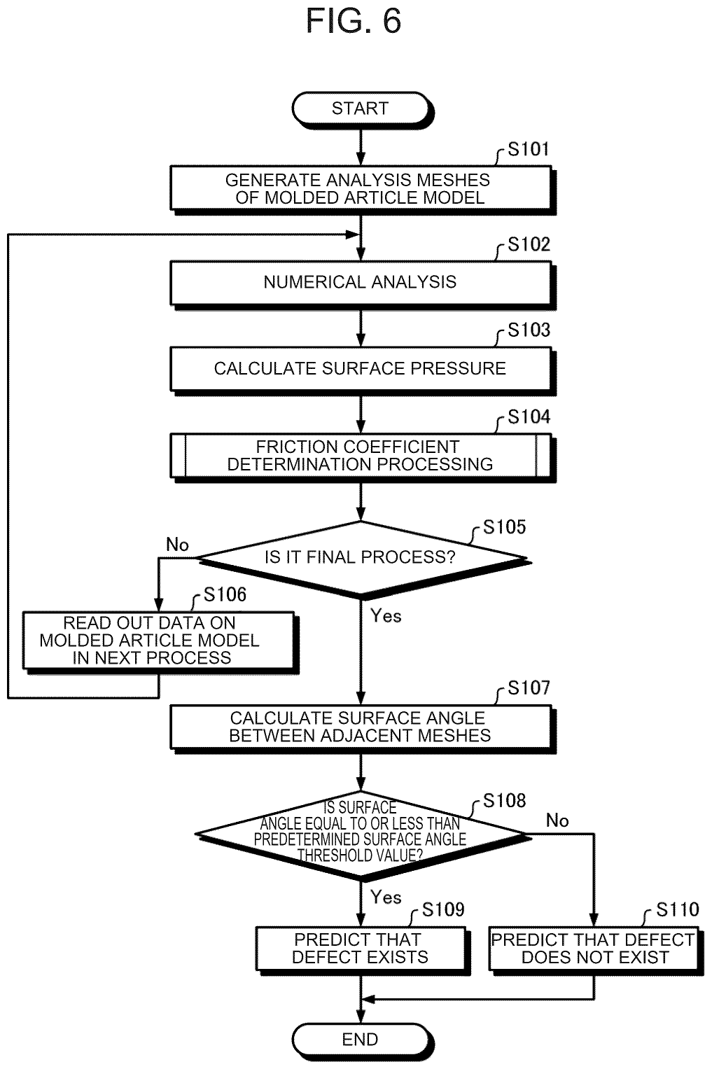

Next, a processing procedure of the forging defect prediction apparatus 10 is described. FIG. 6 is a flowchart showing a processing procedure of the forging defect prediction apparatus 10 shown in FIG. 2. As shown in FIG. 6, the forging defect prediction apparatus 10 generates a plurality of analysis meshes of the molded object model (step S101). The forging defect prediction apparatus 10 performs numerical analysis with use of a finite element method (step S102).

Subsequently, the forging defect prediction apparatus 10 calculates the surface pressure with respect to each mesh (step S103). Subsequently, the forging defect prediction apparatus 10 performs friction coefficient determination processing based on the surface pressure (step S104). Then, the forging defect prediction apparatus 10 determines whether it is the final process (step S105).

When it is not the final process (step S105: No), the forging defect prediction apparatus 10 reads out data on the molded object model in the next process (step S106) and proceeds to step S102. Meanwhile, when it is the final process (step S105: Yes), the forging defect prediction apparatus 10 calculates the surface angle between adjacent surfaces of the analysis meshes (step S107).

Then, the forging defect prediction apparatus 10 determines whether the surface angle of the analysis mesh with respect to an adjacent surface is less than a predetermined angle threshold value (step S108). Subsequently, when the surface angle between the adjacent surfaces of the analysis meshes is equal to or less than the predetermined angle threshold value (step S108: Yes), the forging defect prediction apparatus 10 predicts that a defect exists (step S109). Meanwhile, when the surface angle between the adjacent surfaces of the analysis meshes is greater than the predetermined angle threshold value (step S108: No), the forging defect prediction apparatus 10 predicts that a defect does not exist (step S110).

### Processing Procedure of Friction Coefficient Determination Processing

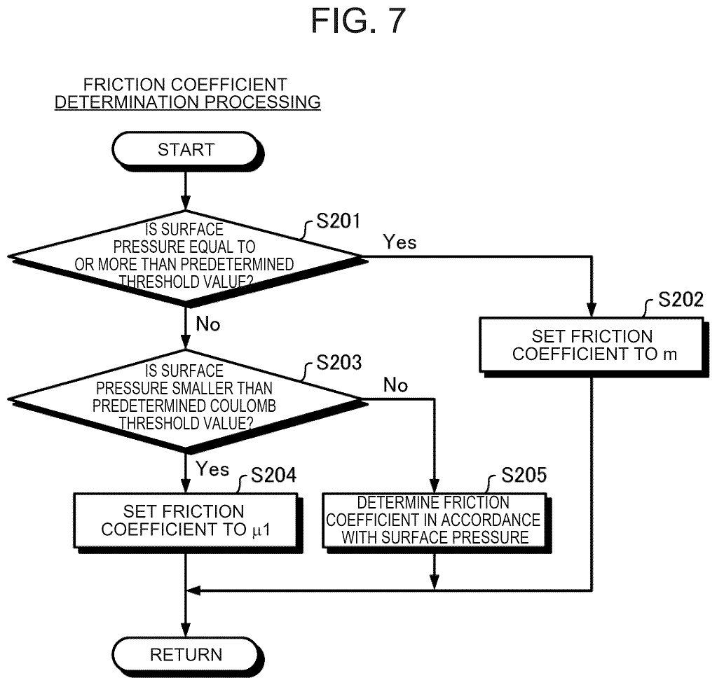

Next, a processing procedure of the friction coefficient determination processing shown in FIG. 6 is described. FIG. 7 is a flowchart showing the processing procedure of the friction coefficient determination processing shown in FIG. 6. As shown in FIG. 7, the forging defect prediction apparatus 10 determines whether the surface pressure is equal to or more than a predetermined threshold value (step S201). Then, when the surface pressure is equal to or more than the predetermined threshold value (step S201: Yes), the forging defect prediction apparatus 10 sets the friction coefficient to m (step S202) and proceeds to step S105 in FIG. 6.

Meanwhile, when the surface pressure is smaller than the predetermined threshold value (step S201: No), the forging defect prediction apparatus 10 determines whether the surface pressure is smaller than a predetermined Coulomb threshold value (step S203). When the surface pressure is smaller than the predetermined Coulomb threshold value (step S203: Yes), the forging defect prediction apparatus 10 sets the friction coefficient to μl and proceeds to step S105 in FIG. 6.

Meanwhile, when the surface pressure is not smaller than the predetermined Coulomb threshold value (step S203: No), the forging defect prediction apparatus 10 determines a friction coefficient in accordance with the surface pressure (step S205) and proceeds to step S105 in FIG. 6.

As described above, in Embodiment 1, the forging defect prediction apparatus 10 generates the analysis meshes of the molded object model, performs finite element analysis, and calculates each mesh surface pressure. Subsequently, the forging defect prediction apparatus 10 determines the friction coefficient based on the surface pressure. In the determination of the friction coefficient, the friction coefficient is determined in accordance with the shear friction law when the surface pressure is equal to or more than the predetermined threshold value, and the friction coefficient is determined in accordance with the Coulomb's law of friction when the surface pressure is smaller than the predetermined Coulomb threshold value. When the surface pressure is greater than the predetermined Coulomb threshold value and is smaller than the predetermined threshold value, the friction coefficient is decreased based on the surface pressure, and the friction coefficient is determined.

### Embodiment 2

In Embodiment 1, a case in which the forging defect prediction apparatus 10 determines the friction coefficient based on the surface pressure has been described. However, in a forging defect prediction apparatus 20 according to Embodiment 2, a case in which the influence of a gap between a material of a raw material and a mold is reflected in the analysis when molding is performed with use of forging is described.

### Overview of Forging Defect Prediction Apparatus 20

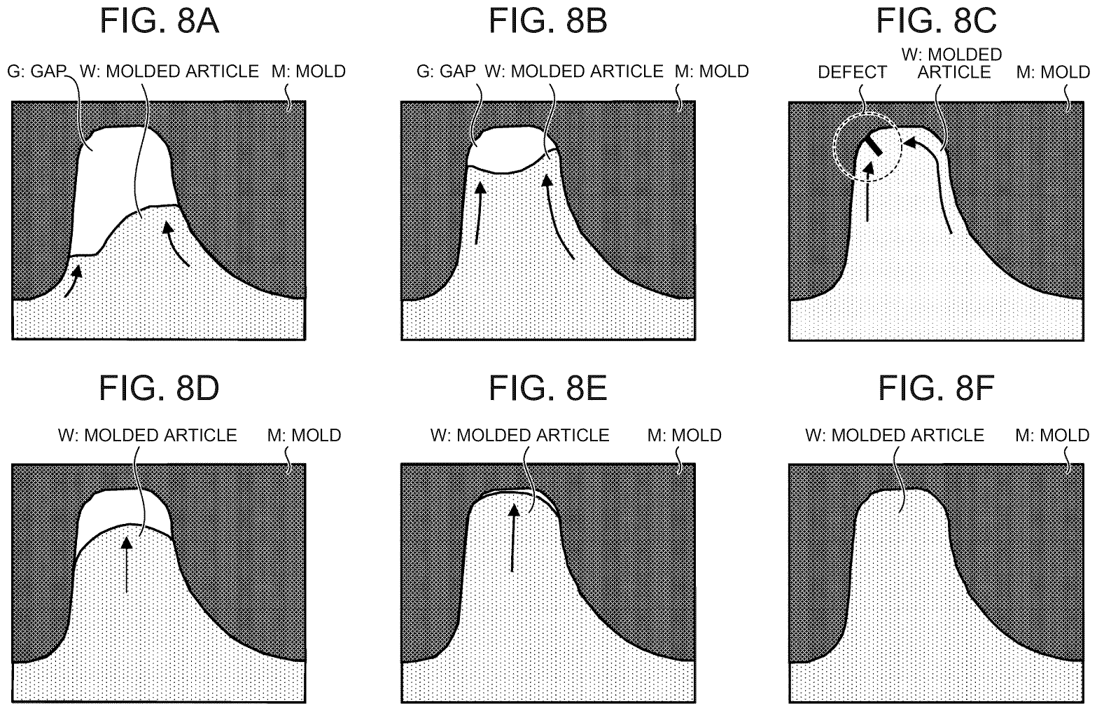

FIG. 8A to FIG. 8F are views showing an overview of the forging defect prediction apparatus 20 according to Embodiment 2. As shown in FIG. 8A to FIG. 8C, when air and the like enter a gap G between a mold M and a molded object W, the forging defect prediction apparatus 20 performs analysis by taking pressure applied to the molded object W due to the air being compressed as the molding process proceeds into account.

For example, as shown in FIG. 8A, air enters a place between the molded object W and the mold M and forms the gap G when the molded object W is pressed against the mold M in a molding process 1. Subsequently, as shown in FIG. 8B, in a molding process 30, the molded object W is further pressed in, and the volume of the gap G becomes smaller by compression as compared to the case of the molding process 1. In this case, the air in the gap G is compressed, and hence the part of the molded object W facing the gap G receives pressure from the gap G, and the speed by which the molded object W plastically deforms becomes slower. Then, as shown in FIG. 8C, in a molding process 100, the molded object W is affected by the pressure of the gap G, and a defect is generated.

Meanwhile, when air and the like have not entered the gap G, the following occurs. As shown in FIG. 8D, even when the molded object W is pressed against the mold M in the molding process 1, pressure and the like are not applied to the molded object W from the gap G although the gap G exists in terms of analysis. Subsequently, as shown in FIG. 8E, in the molding process 30, the molded object W is further pressed in by plastic deformation in the direction of the arrow. Then, as shown in FIG. 8F, in the molding process 100, the molded object W is plastically deformed into the mold M. In this case, it is difficult to reproduce the defect in the molded object W by analysis.

### Pressure in Gap G

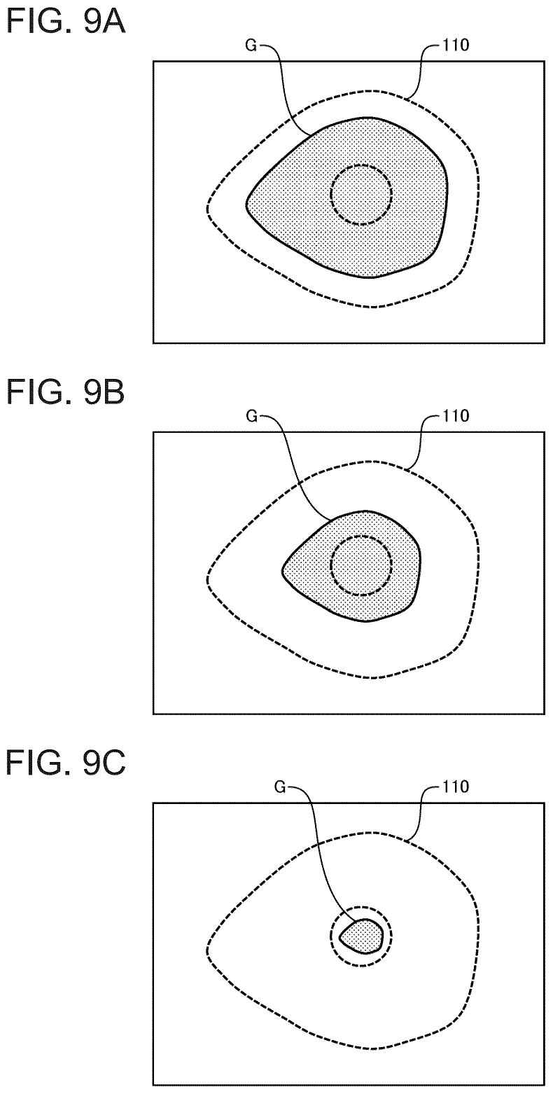

Next, the pressure in the gap G is described. FIG. 9A to FIG. 9C are explanatory diagrams for describing the change of the gap G. As shown in FIG. 9A, in the molding process 1, a state in which the gap G exists in the molded object model 110 is shown. Air exists in the gap G, and the air has an air pressure of 1 atmosphere, for example, in the molding process 1. The gap G is a closed space configured by the molded object W and the mold M.

Then, as shown in FIG. 9B, in the molding process 30, the volume of the gap G decreases by the plastic deformation of the molded object W. The pressure×the volume of the gap G that is a closed space is constant. Therefore, when the volume of the gap G decreases, the pressure in the gap G becomes a value greater than 1 atmosphere. Subsequently, as shown in FIG. 9C, in the molding process 100, the volume of the gap G becomes even smaller, and the pressure in the gap G becomes even greater than the pressure in the molding process 30. When the forging defect prediction apparatus 20 analyzes the plastic deformation of the molded object W, the forging defect prediction apparatus 20 performs the analysis by taking the pressure in the gap G into account.

### Configuration of Forging Defect Prediction Apparatus 20

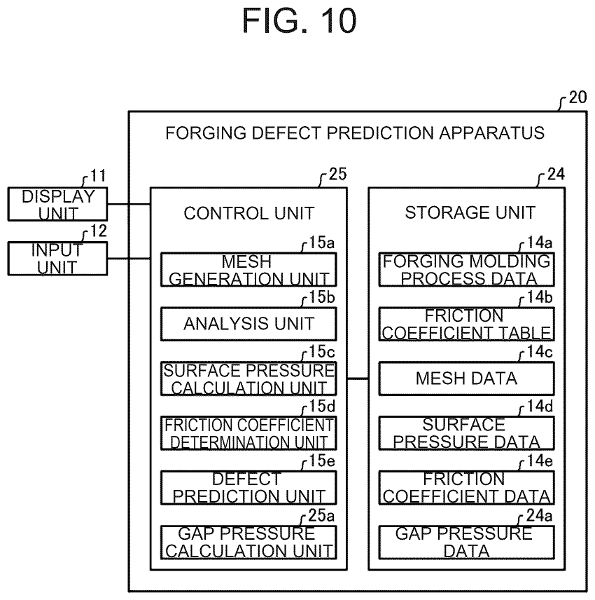

Next, a configuration of the forging defect prediction apparatus 20 is described. FIG. 10 is a functional block diagram showing the configuration of the forging defect prediction apparatus 20 according to Embodiment 2. Sections similar to those of the forging defect prediction apparatus 10 shown in FIG. 2 are denoted by the same reference characters, and detailed description thereof is omitted.

As shown in FIG. 10, the forging defect prediction apparatus 20 includes the display unit 11, the input unit 12, a storage unit 24, and a control unit 25. The storage unit 24 is a storage device such as a hard disk apparatus or a non-volatile memory and stores therein the forging molding process data 14a, the friction coefficient table 14b, the mesh data 14c, the surface pressure data 14d, the friction coefficient data 14c, and gap pressure data 24a. The gap pressure data 24a is data on pressure of the air existing between the molded object W and the gap G.

The control unit 25 is a control unit that controls the entire forging defect prediction apparatus 20 and includes the mesh generation unit 15a, the analysis unit 15b, the surface pressure calculation unit 15c, the friction coefficient determination unit 15d, the defect prediction unit 15e, and a gap pressure calculation unit 25a. In practice, processes corresponding to the mesh generation unit 15a, the analysis unit 15b, the surface pressure calculation unit 15c, the friction coefficient determination unit 15d, the defect prediction unit 15e, and the gap pressure calculation unit 25a are executed by loading programs thereof into the CPU and executing those programs.

The gap pressure calculation unit 25a is a processing unit that calculates the pressure of the air that exists in the gap G between the molded object W and the mold M. Specifically, When the volume V of the air decreases in the finite element analysis, Pa is calculated by computing Pa=C/V based on Pa of the air×the volume V of the air=C. The calculated pressure Pa of the air is set as a parameter of the pressure at a mesh contact point in the molded object model in contact with the gap G in the finite element analysis.

### Processing Procedure of Forging Defect Prediction Apparatus 20

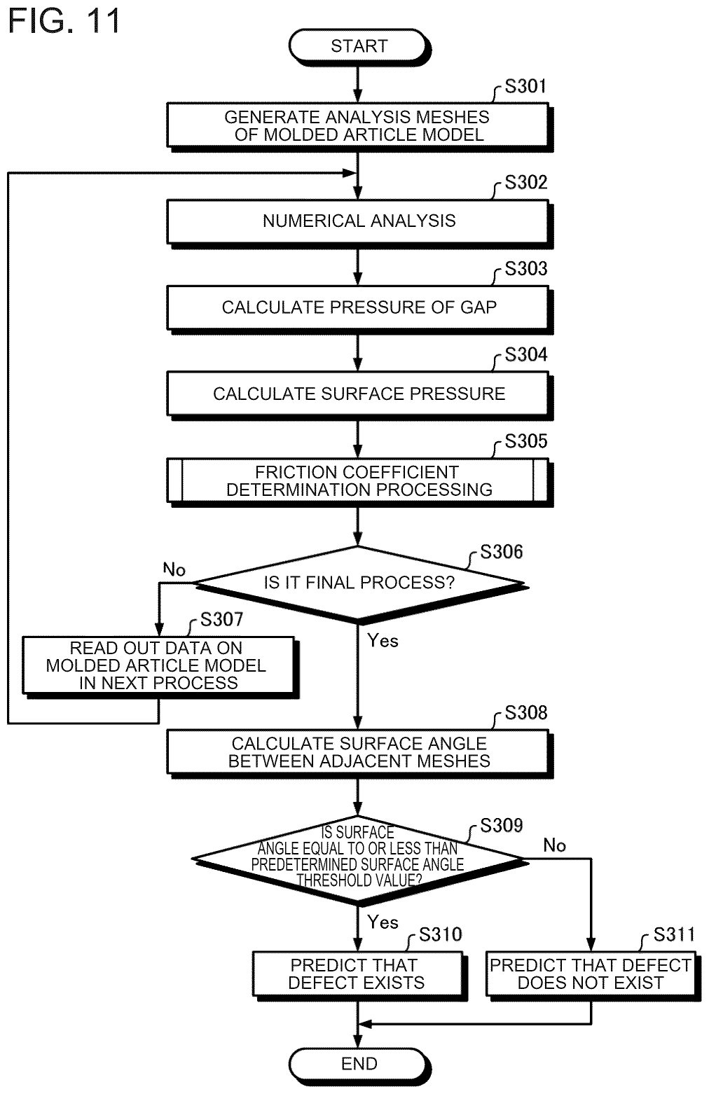

Next, a processing procedure of the forging defect prediction apparatus 20 is described. FIG. 11 is a flowchart showing a processing procedure of the forging defect prediction apparatus 20 shown in FIG. 10. As shown in FIG. 11, the forging defect prediction apparatus 20 generates analysis meshes of a molded object model (step S301). Then, the forging defect prediction apparatus 20 performs numerical analysis with use of a finite element method (step S302). In the numerical analysis, analysis is performed based on the pressure of the gap G and the friction coefficient between the molded object W and the mold M that have been calculated.

Subsequently, the forging defect prediction apparatus 20 calculates the pressure of the gap (step S303). Then, the forging defect prediction apparatus 20 calculates the surface pressure with respect to each mesh (step S304). Subsequently, the forging defect prediction apparatus 20 performs friction coefficient determination processing based on the surface pressure (step S305). Then, the forging defect prediction apparatus 20 determines whether it is the final process (step S306).

When the forging defect prediction apparatus 20 determines that it is not the final process (step S306: No), the forging defect prediction apparatus 20 reads out data on the molded object model in the next process (step S307) and proceeds to step S302. Meanwhile, when it is the final process (step S306: Yes), the forging defect prediction apparatus 20 calculates the surface angle between adjacent surfaces of the analysis meshes (step S308).

Then, the forging defect prediction apparatus 20 determines whether the surface angle between the adjacent surfaces of the analysis meshes is equal to or less than a predetermined angle threshold value (step S309). Subsequently, when the surface angle between the adjacent surfaces of the analysis meshes is equal to or less than the predetermined angle threshold value (step S309: Yes), the forging defect prediction apparatus 20 predicts that a defect exists (step S310). Meanwhile, when the surface angle between the adjacent surfaces of the analysis meshes is greater than the predetermined angle threshold value (step S309: No), the forging defect prediction apparatus 20 predicts that a defect does not exist (step S311). The processing procedure of the friction coefficient determination processing is similar to that of the forging defect prediction apparatus 10, and hence the description of details thereof is omitted.

As described above, in Embodiment 2, the forging defect prediction apparatus 20 generates the analysis meshes of the molded object model, performs finite element analysis, calculates the pressure of the gap, and calculates each mesh surface pressure. Subsequently, the forging defect prediction apparatus 20 determines the friction coefficient based on the surface pressure. In the determination of the friction coefficient, the friction coefficient is determined in accordance with the shear friction law when the surface pressure is equal to or more than the predetermined threshold value, and the friction coefficient is determined in accordance with the Coulomb's law of friction when the surface pressure is smaller than the predetermined Coulomb threshold value. When the surface pressure is greater than the predetermined Coulomb threshold value and is smaller than the predetermined threshold value, the friction coefficient is decreased based on the surface pressure, and the friction coefficient is determined.

Relationship with Hardware

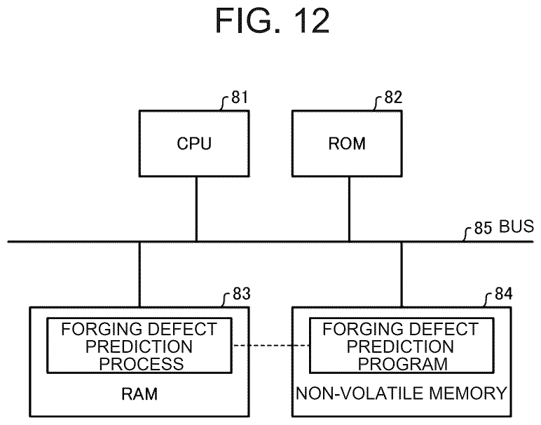

Next, the correspondence between the forging defect prediction apparatus 10 according to Embodiment 1 and a main hardware configuration of a computer is described. FIG. 12 is a diagram showing an example of a hardware configuration.

In general, the computer has a configuration in which a CPU 81, a ROM 82, a RAM 83, a non-volatile memory 84, and the like are connected by a bus 85. A hard disk apparatus may be provided instead of the non-volatile memory 84. For explanatory convenience, only a basic hardware configuration is shown.

Here, a program and the like necessary for the start-up of an operating system (hereinafter simply referred to as an “OS”) are stored in the ROM 82 or the non-volatile memory 84, and the CPU 81 reads and executes the program of the OS from the ROM 82 or the non-volatile memory 84 at the time of power-on.

Meanwhile, various application programs to be executed on the OS are stored in the non-volatile memory 84, and processes corresponding to applications are executed as a result of the CPU 81 executing the application programs while using the RAM 83 as a main memory.

The forging defect prediction program of the forging defect prediction apparatus 10 according to Embodiment 1 is also stored in the non-volatile memory 84 and the like as with other application programs, and the CPU 81 loads and executes the forging defect prediction program. In the case of the forging defect prediction apparatus 10 according to Embodiment 1, a forging defect prediction program including routines corresponding to the mesh generation unit 15a, the analysis unit 15b, the surface pressure calculation unit 15c, the friction coefficient determination unit 15d, and the defect prediction unit 15e shown in FIG. 2 is stored in the non-volatile memory 84 and the like. As a result of the forging defect prediction program being loaded and executed by the CPU 81, a forging defect prediction process corresponding to the mesh generation unit 15a, the analysis unit 15b, the surface pressure calculation unit 15c, the friction coefficient determination unit 15d, and the defect prediction unit 15e is generated.

Each configuration illustrated in each embodiment is a functional overview and does not necessarily need to physically have the illustrated configuration. In other words, the form of distribution and integration of each apparatus is not limited to the illustrated form, and all or a part thereof can be configured by being functionally or physically distributed or integrated in freely-selected units in accordance with various loads, usage conditions, and the like.

The forging defect prediction apparatus, the forging defect prediction method, and the forging defect prediction program according to the present disclosure are suitable for a case in which the occurrence of a defect phenomenon is suitably and efficiently predicted when forging molding is performed.

What is claimed is:

1. A forging defect prediction apparatus configured to generate a molded object model in a plurality of molding processes of forging molding and predict, based on the molded object model, whether a defect phenomenon occurs when a molded object is molded by each of the molding processes of the forging molding, the forging defect prediction apparatus comprising a processor configured to:
calculate, based on a stress applied to a plurality of analysis meshes configuring the molded object model, a surface pressure of each of the analysis meshes;
determine that a friction coefficient is Coulomb friction when the surface pressure of each of the analysis meshes is equal to or less than a predetermined threshold value and determine that the friction coefficient is shear friction when the surface pressure is greater than the predetermined threshold value;
analyze the analysis mesh while switching the determined friction coefficient; and
predict whether the defect phenomenon that occurs in the molded object model occurs based on a surface angle between surfaces of adjacent ones of the analysis meshes.

2. The forging defect prediction apparatus according to claim 1, wherein:
the analysis mesh in each of the molding processes includes a plurality of nodes; and
the processor is configured to calculate the surface pressure based on an average value of a stress applied to the nodes.

3. The forging defect prediction apparatus according to claim 1, wherein the processor is configured to:
determine the friction coefficient of the Coulomb friction when the surface pressure is smaller than a predetermined Coulomb threshold value based on the surface pressure; and
decrease the friction coefficient based on the surface pressure when the surface pressure is greater than the Coulomb threshold value and is smaller than the predetermined threshold value.

4. The forging defect prediction apparatus according to claim 1, wherein the processor is configured to predict that the defect phenomenon occurs when the surface angle between the surfaces of the adjacent analysis meshes is equal to or smaller than a predetermined angle threshold value and predict that the defect phenomenon does not occur when the surface angle between the surfaces of the adjacent analysis meshes is more than the predetermined angle threshold value.

5. The forging defect prediction apparatus according to claim 1, wherein:
the processor is configured to calculate, when a gap exists between the molded object and a mold of the forging molding, a pressure of gas that exists in the gap; and
configured to analyze the analysis mesh based on the pressure of the gas.

6. A forging defect prediction method in a forging defect prediction apparatus configured to generate a molded object model in a plurality of molding processes of forging molding and predict, based on the molded object model, whether a defect phenomenon occurs when a molded object is molded by each of the molding processes of the forging molding, the forging defect prediction method comprising:
a surface pressure calculating step of calculating, based on a stress applied to a plurality of analysis meshes configuring the molded object model, a surface pressure of each of the analysis meshes;
a determination step of determining that a friction coefficient is Coulomb friction when the surface pressure of each of the analysis meshes is equal to or less than a predetermined threshold value and determining that the friction coefficient is shear friction when the surface pressure is greater than the predetermined threshold value;
an analysis step of analyzing the analysis mesh while switching the friction coefficient determined by the determination step; and
a prediction step of predicting whether the defect phenomenon that occurs in the molded object model occurs based on a surface angle between surfaces of adjacent ones of the analysis meshes analyzed by the analysis step.

7. A non-transitory storage medium storing instructions that cause a processor to execute functions, the processor being included in a forging defect prediction apparatus configured to generate a molded object model in a plurality of molding processes of forging molding and predict, based on the molded object model, whether a defect phenomenon occurs when a molded object is molded by each of the molding processes of the forging molding, the functions comprising:
calculating, based on a stress applied to a plurality of analysis meshes configuring the molded object model, a surface pressure of each of the analysis meshes;
determining that a friction coefficient is Coulomb friction when the surface pressure of each of the analysis meshes is equal to or less than a predetermined threshold value and determining that the friction coefficient is shear friction when the surface pressure is greater than the predetermined threshold value;
analyzing the analysis mesh while switching the friction coefficient; and
predicting whether the defect phenomenon that occurs in the molded object model occurs based on a surface angle between surfaces of adjacent ones of the analysis meshes.
